(19) United States
(12) Patent Application Publication
(10) Pub. No.: US 2005/0116837 A1
(43) Pub. Date: Jun. 2, 2005

(54) Traffic control malfunction management unit with selectable dual D.C. voltage monitoring

(75) Inventor: Allen Jacobs, Reno, NV (US)

Correspondence Address: Warren P. Kujawa;#4, 434 Larkin St., Monterey, CA, 93940, US

(73) Assignee: RENO AGRICULTURE AND ELECTRONICS, Reno, NV (US)

(21) Appl. No.: 10/719,127

(22) Filed: Nov. 20, 2003

(51) Int. Cl. G08G 1/097

(52) U.S. Cl. 340/931; 340/660; 340/511

(57) ABSTRACT

A malfunction management method and apparatus for monitoring the levels of D.C. voltage supply signals from power supplies used to power associated traffic control equipment. A D.C. voltage from each power supply is checked against a reference threshold value in the malfunction management unit. If either voltage drops below the threshold value for a minimum time period, a fault signal is generated and the operation of the traffic control equipment is overridden. The threshold value used to test the D.C. voltage levels is selectable between the same level for all inputs or different levels for different inputs.

### BACKGROUND OF THE INVENTION

This invention relates to traffic control equipment used to monitor the states of traffic signal head control signals for conflicts. More particularly, this invention relates to a malfunction management unit which monitors the D.C. supply voltages from traffic control equipment power supplies for proper voltage levels.

Traffic signal heads and pedestrian advisory signs are commonly used to regulate the flow of vehicular and pedestrian traffic. A typical traffic signal head is provided with red, yellow, and green A.C. operated light sources, while a typical pedestrian advisory sign has A.C. operated “WALK” and DON'T WALK” light sources. Controller assemblies are widely used in the traffic control industry for generating the A.C. control signals used to operate the individual light elements of the traffic signal heads and the pedestrian advisory signs. For safety reasons, the traffic control industry has long used equipment to monitor the states of the electrical power signals used to operate the traffic signal head light elements and the pedestrian advisory sign light elements for conflicts. Under the TS-1 standard, this equipment is called a conflict management unit (CMU); under the later TS-2 standard, this equipment is called a malfunction management unit (MMU). There are many specific types of signal conflicts which are monitored by existing CMUs and MMUs in accordance with the TS-1 and TS-2 standards. In all cases, the CMU or MMU responds to signal conflicts by overriding the operation of the intersection controller assembly and taking control of the operation of the traffic signal head. A common method is to place the traffic signal light sources in a flashing mode of operation by switching the states of dedicated electrical relays. These dedicated relays remain in this flashing mode until the source of the conflict problem is diagnosed and fixed.

In addition to monitoring for signal conflicts, known CMUs and MMUs also monitor the voltage level of the D.C. power supplies used to power the controller assemblies. Under the normal U.S. standard, a controller assembly power supply nominally provides 24 volts D.C. to the controller assembly. If this supply voltage drops below a predetermined value required to guarante reliable operation for the controller assembly, the monitoring CMU or MMU generates a fault signal which triggers the controller assembly override operation. Under the current standard, an MMU must have two 24 V.D.C. monitoring inputs to provide two independent monitoring input circuits. While this provides sufficient capability for monitoring the state of the controller assembly power supply, it does not address the issue of other power supplies which are typically present in the controller assembly cabinet and which generate D.C. supply voltages of other values (most commonly 12 V.D.C.) used to power other equipment (typically one or more vehicle detectors) whose proper operation is vital to the performance of the controller assembly. Should this other type of power supply fail, then the entire controller assembly operation can be compromised. Consequently, existing MMUs with only D.C. voltage monitoring of a single type (i.e., 24 V.D.C. monitoring) have no way of detecting the failure of a second power supply of a different type, which is highly undesirable.

### SUMMARY OF THE INVENTION

The invention comprises a malfunction management unit for traffic signal control equipment which monitors for proper level D.C. supply voltages of a first magnitude and optionally monitors for proper level D.C. supply voltages of a second magnitude so that the proper functioning of both the controller assembly and any complementary traffic control equipment in the controller assembly cabinet can be assured; otherwise a fault is detected.

From an apparatus standpoint, the invention comprises a traffic control equipment malfunction management unit having at least two input terminals for receiving D.C voltage signals from at least two power supplies used to provide power to associated traffic control equipment, processing circuitry for monitoring the level of the D.C voltage present on each input terminal and for generating a fault signal when either D.C. voltage level falls below a predetermined threshold value, and threshold circuitry for selectably providing at least two different threshold values for at least two terminals. The threshold circuitry preferably includes a manually actuatable switch for enabling manual selection between a single threshold value for at least two terminals and two different threshold values for at least two terminals. The malfunction management unit preferably includes a display for indicating whether one or two threshold values have been selected.

From a method standpoint, the invention comprises a method of monitoring D.C voltage signals from two power supplies used to provide power to traffic control equipment, the method comprising the steps of applying the D.C. voltage signals from the power supplies to two separate input terminals, monitoring the level of the D.C voltage present on each input terminal, generating a fault signal when either D.C. voltage level falls below a predetermined threshold value, and selectably providing at least two different threshold values for the two terminals. The step of selectably providing preferably includes the step of manually selecting between a single threshold value for the two terminals and two different threshold values for the two terminals. The method further preferably includes the step of providing a visible indication whether one or two threshold values have been selected.

The selectability of the D.C. voltage processing to one of two different levels for voltage inputs is very useful in installations having power supplies which generate D.C. supply voltages of two different levels—e.g., one 24 volts D.C. power supply for the controller assembly, and one 12 volts D.C. power supply for the associated vehicle detectors. By virtue of one switch setting, either dual same voltage or dual different voltage processing can be specified. This adds further flexibility and usefulness to an MMU.

For a fuller understanding of the nature and advantages of the invention, reference should be had to the ensuing detailed description taken in conjunction with the accompanying drawings.

### BRIEF DESCRIPTION OF THE DRAWINGS

FIG. 1 is a block diagram of a malfunction management unit incorporating the invention;

FIG. 2 is a view of the front panel of the malfunction management unit of FIG. 1 showing the settable switches and displays incorporated into the preferred embodiment of the invention.

### DETAILED DESCRIPTION OF THE PREFERRED EMBODIMENTS

Turning now to the drawings, FIG. 1 is a block diagram of a malfunction management unit incorporating the invention. As seen in this Fig., the malfunction management unit (MMU) includes a main processor 12, preferably an AMD Am186CH-40 16-bit microprocessor, and nine microcontrollers. One of these microcontrollers designated with reference numeral 14 is used for digital conversion of nine D.C. voltage inputs from the several D.C. voltage sources used in the associated traffic control system. This microcontroller is preferably an Atmel AT90LS8535 device. Seven of the microcontrollers collectively designated with reference numeral 16 are used for digital conversion of fifty six A.C. voltage inputs from the traffic control unit, with each microcontroller handling eight A.C. voltage inputs. An A.C. line zero crossing unit 18 provides zero crossing information to main processor 12. A program card reader 20 provides programming information relating to configuration parameters read from a programming card 21 described in detail below. A plurality of settable switches 22 mounted on the front panel of the MMU housing enable operator selection of several different functions for individual channels as described more fully below. An RS-232 serial port 24 enables communications between the MMU and a laptop computer for local communications and a modem for remote communications. An SDLC port 26 enables communications with the traffic controller. A temperature sensor 27 is provided to monitor the temperature inside the cabinet housing the MMU and the traffic controller. A real time clock 28 provides a real time reference for the main processor.

The main processor 12 is coupled to a program memory unit 30, RAM memory unit 32 and non-volatile memory unit 34. The purpose of each of these memory units is described more fully below. Main processor is also coupled to a front panel display 40 shown in FIG. 2; an audible buzzer 41; a start delay relay 42; and a fault relay 43. The structure and function of units 40-43 are described more fully below.

FIG. 2 illustrates the front panel of the MMU. As seen in this Fig., a program card slot 51 enables a user to insert and remove programming card 21. Sixteen two position switches 52 enable operator selection of the Field Check/Dual Enable functions described more fully below on a per channel basis. Eight two position switches 54 enable operator selection of different options. These options are termed “Convert 24 V-2 to 12 VDC”; “Per Channel Red Enable”; “Disable Local Flash”; “Modified CVM Latch”; “GY Monitoring Enable”; “Watchdog Enable”; “Flash DW Enable”; and “Type 16 Only” and are individually described in detail below.

A first display group 56 comprising sixty LED indicators provides field status indications for the various Red, Yellow, Green and Walk field inputs. A second display group 58 provides fault information relating to the status of specific fault conditions and whether the particular fault test is enabled or disabled. A pair of connectors (A and B) provide electrical connections for the various input signals described above with reference to FIG. 1. Connector A has one contact which is coupled to a first D.C. power supply output voltage terminal, while connector B has one contact which is coupled to a second D.C. power supply output voltage terminal.

A Power LED 59 indicates whether power is being applied to the MMU; while a Type 12 LED 60 indicates whether the user has selected Type 12, Type 16, or Type 16 only modes of operation, described below. Lastly, a Reset button switch 61 enables a technician to attempt manual reset of faults recorded by the MMU. Pushing this button also turns on all display LEDs for a period of time sufficient to visually determine that all LEDs are operational.

### Selectable Dual D.C. Voltage Monitoring

The present invention is directed to the selectable dual voltage monitoring function incorporated into the MMU described herein. As noted above with reference to FIG. 2, one of the contacts of connector A (termed the 24V-1 input) is coupled to an output terminal of a first power supply. The D.C. voltage on this contact is processed and monitored in the following manner. A voltage greater than +22 volts D.C. is recognized by the MMU as adequate for the proper operation of the controller assembly. A voltage of less than +18 volts D.C. is recognized as inadequate for proper operation of the controller assembly. When the input voltage on the 24V-1 input is detected as inadequate for more than 175 milliseconds, the MMU transfers the output relay contacts to the fault condition, illuminates the 24V-1 LED indicator in display group 58, and records the fault in memory.

Connector B has a contact (termed the 24V-2 input) which is coupled to an output terminal of a second power supply. If this second power supply provides a nominal voltage of 24 volts D.C., the input voltage on terminal 24V-2 is processed in the same manner as that on terminal 24V-1. However, the processing of the input voltage on terminal 24V-2 can be changed to 12 volts D.C. processing, described below, by operation of the options switch in switch group 54 labelled “Convert 24V-2 to 12 VDC” to the ON stat . When this is done, a voltage greater than +11.5 volts D.C. is recognized by the MMU as adequate for the proper operation of the associated equipment. A voltage of less than +10.75 volts D.C. is recognized by the MMU as inadequate for the proper operation of this associated equipment. When the input voltage on the 24V-2 input is detected as inadequate for more than 175 milliseconds, the MMU transfers the output relay contacts to the fault condition, illuminates the 24V-2 LED indicator in display group 58, and records the fault in memory.

It is noted that the absence of the proper voltage level at either one of input terminals 24V-1 and 24V-2, regardless of whether 24V-2 input voltages are subject to 24 volts or 12 volts processing, causes the MMU to transfer the output relay contacts to the fault condition. Restoration of all proper voltage levels resets the voltage monitoring section of the MMU.

The selectability of the D.C.voltage processing to one of two different levels for voltage inputs on terminal 24V-2 has been found to be very useful in installations having power supplies which generate D.C. supply voltages of two different levels—e.g., one 24 volts D.C. power supply for the controller assembly, and one 12 volts D.C. power supply for the associated vehicle detectors. By virtue of one switch setting, either dual 24 VDC or 24/12 VDC input voltage processing can be specified. This adds further flexibility and usefulness to an MMU.

A complete description of the MMU comprising the preferred embodiment of the invention is attached hereto as Appendix A and forms an integral part of this disclosure.

Although the above provides a full and complete disclosure of the preferred embodiments of the invention, various modifications, alternate constructions and equivalents will occur to those skilled in the art. For example, although specific microprocessors and microcontrollers have been identified for the preferred embodiment, other such devices may be employed in the implementation of the invention.Therefore, the above should not be construed as limiting the invention, which is defined by the appended claims.

1. In a traffic control equipment malfunction management unit having at least two input terminals for receiving D.C voltage signals from at least two power supplies used to provide power to associated traffic control equipment, and processing circuitry for monitoring the level of the D.C voltage present on each input terminal and for generating a fault signal when either D.C. voltage level falls below a predetermined threshold value; the improvement comprising threshold circuitry for selectably providing at least two different threshold values for at least two terminals.

2. The invention of claim 1 wherein said threshold circuitry includes a manually actuatable switch for enabling manual selection between a single threshold value for said at least two terminals and two different threshold values for at least two terminals.

3. The invention of claim 1 wherein said malfunction management unit includes a display for indicating whether one or two threshold values have been selected.

4. In a method of monitoring D.C voltage signals from two power supplies used to provide power to traffic control equipment, said method comprising the steps of applying the D.C. voltage signals from said power supplies to two separate input terminals, monitoring the level of the D.C voltage present on each input terminal, and generating a fault signal when either D.C. voltage level falls below a predetermined threshold value; the improvement comprising the step of selectably providing at least two different threshold values for said two terminals.

5. The invention of claim 4 wherein said step of selectably providing includes the step of manually selecting between a single threshold value for said two terminals and two different threshold values for said two terminals.

6. The invention of claim 4 wherein said method further includes the step of providing a visible indication whether one or two threshold values have been selected.
